(19) United States
(12) Patent Application Publication
(10) Pub. No.: US 2012/0070794 A1
(43) Pub. Date: Mar. 22, 2012

(54) FUNCTIONALIZED ADHESIVE COATED ORTHODONTIC APPLIANCES

(75) Inventors: Bradley D. Craig, Lake Elmo, MN (US); Tsi-Zong Tzou, Arcadia, CA (US)

(73) Assignee: 3M Innovative Properties Company

(21) Appl. No.: 13/227,756

(22) Filed: Sep. 8, 2011

Related U.S. Application Data
(60) Provisional application No. 61/383,353, filed on Sep. 16, 2010.

(51) Int. Cl. A61C 7/16; B05D 5/10; B05D 3/12

(52) U.S. Cl. 433/9; 427/2.29

(57) ABSTRACT

Provided are methods for making adhesive coated orthodontic appliances having a silane treated metallic bonding surface, and related assemblies. Exemplary methods of making an adhesive coated orthodontic appliance include providing a metallic bonding surface on the orthodontic appliance for attachment to a tooth surface, sand blasting the bonding surface with a silica-based media, functionalizing the bonding surface in the presence of a pH-modified coupling agent solution, and applying an adhesive onto at least a portion of the bonding surface, where the adhesive is a hydrophilic adhesive having a water uptake of at least 0.5 percent of its original weight after hardening.

### CROSS-REFERENCE TO RELATED APPLICATIONS

This application claims the benefit of U.S. Provisional Application Serial No. 61/383,353, filed Sep. 16, 2011, the disclosure of which is incorporated by reference herein.

### 1. FIELD OF THE INVENTION

The present invention is directed to orthodontic appliances and related methods of manufacture. More particularly, the present invention is directed to adhesive coated orthodontic appliances and related methods of manufacture.

### 2. DESCRIPTION OF THE RELATED ART

Orthodontics is a specialty of dentistry concerned with the study and treatment of malocclusions, or improper bites, which may be a result of tooth irregularity, disproportionate jaw relationships, or both. This is achieved by the application and/or re-direction of forces to teeth to bring them into proper positions relative to each other and relative to facial bones. Orthodontic treatment may be carried out to improve the general appearance of patients' teeth and face for cosmetic reasons. Often orthodontic treatment is also prescribed for practical reasons, providing the patient with a functionally improved bite.

One common type of treatment, called fixed appliance therapy, uses tiny slotted appliances called brackets. At the beginning of treatment, the brackets are coupled to a patient's teeth and a resilient archwire is placed in the slot of each bracket. The ends of the archwire are then received in appliances called molar tubes, which are affixed to the patient's molar teeth. The archwire deflects when initially installed and then imparts continuous forces to urge the teeth to proper locations as it returns to its original shape. The combination of brackets, buccal tubes, and archwires is commonly referred to as “braces”.

Brackets and molar tubes are usually coupled directly to their respective teeth using a suitable adhesive. Alternatively, an appliance may be welded or brazed to a thin, circular strip of metal, called a band, which is in turn adhesively secured in encircling relation with the tooth. Using adhesives to affix appliances to teeth is both convenient and popular amongst orthodontic practitioners today. However, the requirements for these adhesives are both challenging and particular to orthodontics. On one hand, adhesive bond strength needs to be sufficiently high to prevent spontaneous bond failure of the appliance during the course of orthodontic treatment. Spontaneous bond failure is a nuisance to both the orthodontic practitioner and patient. On the other hand, bond strength should not be so high that removal of the appliance at the end of treatment is unduly difficult or presents risk of tooth damage. An ideal adhesive should display both consistent and predictable bond strength in every day use.

To provide for consistent bond strength between the tooth and the appliance, it is desirable to have a consistent adhesion between the appliance and the adhesive. This is typically achieved using mechanical means, such as by providing undercut structures in the appliance that mechanically retain the unhardened adhesive. An example which has seen widespread commercial use is the mesh base described, for example, in U.S. Pat. Nos. 5,110,290 (Wong) and 5,295,823 (Farzin-Nia). Other mechanical approaches involve microetching the bracket to enhance bond strength at the bracket-adhesive interface. In these cases, the adhesive is interlocked with these undercut structures when it is eventually hardened, thereby forming a strong bond.

### SUMMARY OF THE INVENTION

Recent attempts have been made to achieve a chemical bond between a metal appliance and an adhesive to further enhance bond strength. Silane coupling agents have already been used to provide chemical bonding between ceramic materials and acrylic-based adhesives. In one ROCATEC brand process, a metallic surface is first silane treated by sandblasting the metal surface with silica media or silica-coated media to impart silica domains onto the metal surface. Then, those silica domains are then chemically functionalized by application of a suitable silane primer. However, studies have shown that this process has not yielded a consistent improvement in bond strength when used with hydrophilic adhesives.

The present invention is directed to an improved method for making an adhesive coated appliance having a silane treated metallic bonding surface, and related assemblies.

In one aspect, a method of making an adhesive coated orthodontic appliance is provided. The method comprises: providing a metallic bonding surface on the orthodontic appliance for attachment to a tooth surface, sand blasting the bonding surface with a silica-based media, functionalizing the bonding surface in the presence of a pH-modified coupling agent solution, and applying an adhesive onto at least a portion of the bonding surface, wherein the adhesive is a hydrophilic adhesive having a water uptake of at least 0.5 weight percent relative to its original weight after hardening.

In another aspect, a packaged orthodontic assembly is provided, comprising an orthodontic appliance having a functionalized metallic bonding surface for attachment to a tooth surface, the bonding surface functionalized in the presence of a pH-modified coupling agent solution; an adhesive in contact with the bonding surface, the adhesive having an average water uptake of at least 0.5 percent of its original weight after hardening; and a container surrounding the orthodontic appliance and adhesive thereon.

### BRIEF DESCRIPTION OF THE DRAWINGS

FIG. 1 is a flowchart that showing a method according to an embodiment of the present invention;

FIG. 2 is a perspective view looking at the base of an orthodontic appliance pre-coated with an exemplary adhesive that is contacted in part by a release substrate; and

FIG. 3 is side cross-sectional view of a certain embodiment of the present invention illustrating a packaged assembly including an orthodontic appliance coated with an exemplary adhesive thereof in a container with a removable cover.

### DEFINITIONS

As used herein:
“Mesial” means in a direction toward the center of the patient's curved dental arch.
“Distal” means in a direction away from the center of the patient's curved dental arch. “Occlusal” means in a direction toward the outer tips of the patient's teeth.
“Labial” means in a direction toward the patient's lips or cheeks.
“Lingual” means in a direction toward the patient's tongue.

### DETAILED DESCRIPTION OF THE PREFERRED EMBODIMENTS

### Methods of Making a Coated Orthodontic Appliance

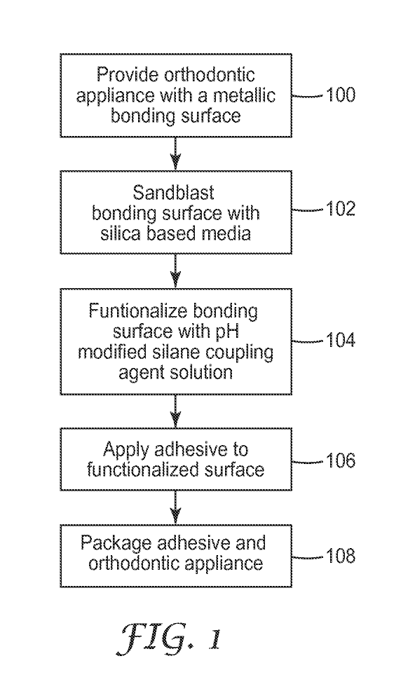

An exemplary method of making a coated orthodontic appliance according to one embodiment is shown in the flowchart of FIG. 1.

The methods disclosed herein may be used with a diverse array of bondable orthodontic appliances, including brackets, buccal tubes, buttons, cleats and sheaths. Moreover, these methods can be used for making appliances suitable for attachment either to the labial or lingual surface of the patient's teeth. In exemplary embodiments, the methods are used to prepare bonding surfaces on an orthodontic appliance, and in particular bonding surfaces used to couple an orthodontic appliance to a tooth surface. Preferably, the substrate surface is metallic. However, other substrates are also possible, including but not limited to substrates having ceramic, glass, or synthetic resin surfaces.

In this embodiment, and as indicated by block 100, an orthodontic appliance provides a metallic bonding surface for attachment to a tooth surface. Metallic bonding surfaces include stainless steel, titanium, silver, gold, nickel-titanium, copper-nickel-titanium and other alloys used in orthodontic appliances. While the entire appliance may be metallic, it is also possible that the appliance may have a substantially non-metallic body with a bonding surface at least partially coated with a metallic layer.

As a further option, the bonding surface can include a retaining structure, such as a stainless steel mesh base, that facilitates bonding the appliance to a patient's tooth. The retaining structure improves the strength of the bond by forming a mechanical lock with a suitable adhesive disposed between the appliance and the tooth surface.

Next, and as indicated in block 102, the bonding surface of the orthodontic appliance is sand blasted with a silica-based media. Various types of silica-based media can be used. As a primary component, the silica-based media includes siliceous material having an average particle size ranging between 2 to 200 micrometers and is present in an amount ranging from 20% to 100% by weight. In some embodiments, the primary component has an average particle size ranging from 5 to 100 micrometers. Exemplary primary components include quartz, quartz glass, silicate glass containing at least 10 weight percent of silicon, silicon carbide, and silicon nitride. Alternatively, the primary component may include a siliceous or non-siliceous material that is at least partially coated with silica. In a preferred embodiment, the primary component includes silica-coated alumina particles.

The silica-based media may also include one or more secondary components. The secondary component includes a material having an average particle size less than 1 micrometer and present in an amount ranging from 0 to 50% by weight and more preferably in an amount ranging from 0 to 30% by weight. Exemplary secondary components include quartz, quartz glass, silicate glass containing at least 10 weight percent of silicon, silicon carbide, silicon nitride, and pyrogenic silicic acid, alumina, titania, zirconia, and other oxides, nitrides, and carbides. Optionally, the secondary component is silanized. Further details concerning the disclosed primary and secondary components are described in issued U.S. Pat. No. 5,024,711 (Gasser, et al.)

As shown by block 104, the bonding surface is then functionalized in the presence of a pH-modified coupling agent solution. As used herein, “pH-modified” refers to an aqueous solution that is either substantially basic (i.e. having a pH greater than or equal to 8.0) or acidic (i.e. having a pH less than or equal to 5.0). In exemplary embodiments, functionalization takes place in three steps: 1) solution or dispersion of the coupling agent, 2) application of the solution to the bonding surface, and then 3) removal of water to functionalize the bonding surface.

Preferably the coupling agent is an organofunctional silane. In exemplary embodiments, the coupling agent solution is formed by hydrolyzing a coupling agent in acidified or basic water to form silanols. Exemplary organofunctional silanes useable for this purpose include vinyl trimethoxysilane, glycidoxypropyl trimethoxysilane, 3-methacryloxypropyltrimethoxysilane and tetramethyl divinyl silazane.

In some embodiments, an organofunctional silane solution may be pH-modified by adding a suitable acid or base into the silane solution and stirring or shaking vigorously until a clear solution is observed. The solvent used is generally water. However, other solvents such as ethanol, isopropyl alcohol, diethyl ether, tertiary butyl methyl ether, and acetone may also be present. For example, in some embodiments, the coupling agent solvent is a mixture of 75 weight percent ethanol and 25 weight percent water.

Various acids and bases may be used to adjust the pH of the solution. For example, the coupling agent solution may be acidified. Suitable acids include glacial acetic acid, trifluoroacetic acid, and other weak acids. Alternatively, a weakly acidic solution may be provided by introduction of a suitable gas. For example, a carbonic acid solution may be achieved by bubbling carbon dioxide gas in water.

Preferably, the acid that is used in modifying pH is reasonably volatile, or easily removed from the final coated surface. By using a volatile acid that readily evolves, residual acid is minimized when the coupling agent solution is dried. Minimizing residual acid, in turn, avoids potential later reversal of the condensation reaction, as well as undesirable interaction between the residual acid and the orthodontic adhesive or orthodontic adhesive interface. For example, the choice of trifluoroacetic acid is particularly advantageous because it is more volatile, thereby minimizing residual acid on the bonding surfaces. Also advantageous is carbonic acid, which forms carbon dioxide upon drying. Carbon dioxide evolves readily with essentially zero acidic residue when the coupling agent solution is dried.

Preferably, an acidic coupling agent solution has a pH ranging from 2.0 to 5.0. More preferably, the pH ranges from 2.8 to 4.6. It was found that these pH ranges effectively hydrolyze the silane, but do not condense the molecules too rapidly to prevent the use of the solution as a stable primer. At higher pH, it was found that the silane does not hydrolyze or condense as effectively. At lower pH, however, the silane tends condense too rapidly.

As another option, a basic solution may be prepared by introducing a suitable amount of base into the coupling agent solution. For example, a dilute 1.0% ammonium hydroxide solution in water may be gradually added into the coupling agent solution to increase pH.

Preferably, a basic coupling agent solution has a pH ranging from 8.0 to 10.0. Most preferably, the pH ranges from 8.5 to 9.2. Coupling agent solutions with a pH in these ranges were found to effectively hydrolyze and condense the silane. At higher pH, the condensation rate increases, and at some point the shelf life of the solution will be significantly decreased due to the increase in the kinetics of the condensation rate. The formation of the oligomer will eventually lead to phase separation (clouding) in either too acidic or too basic of environments, especially when significant water is present in the silane coating solution.

Use of a basic silane coupling agent solution offers certain advantages over the use of an acidic silane solution. First, a higher degree of conversion can be achieved in functionalizing the bonding surface, especially when the base is provided by an amine as with ammonium hydroxide. Second, any residual base from the coupling agent solution is chemically compatible with adhesives that use initiator systems containing amine catalysts, such as ethyl (4-dimethyl amino) benzoate (EDMAB). Residual acid, by comparison, can adversely react with the amine catalyst and lead to an incomplete cure. Third, a more stable system can be realized. Residual base neither interferes with the stability of existing methacrylate resins nor induces reversal of the condensation reaction after silane has been applied. Residual acid, on the other hand, can undergo hydrolysis with the methacrylate resins, thereby reducing the overall stability of the system. A chemically stable system is especially advantageous when dealing with a packaged adhesive-coated appliance, which should have as long a shelf-life as possible.

In preferred embodiments, the pH-modified coupling agent solution contains a coupling agent present in an amount ranging from 0.1 percent to 4 percent by weight. More preferably, the coupling agent is present in an amount ranging from 0.25 percent to 2 percent by weight. Preferably, the acid is present in an amount ranging from about 0.5 percent to about 1.5 percent by weight.

Second, the coupling agent solution is applied to the bonding surface of the orthodontic appliance. The solution is typically applied by brushing a thin layer onto the bonding surface.

Third, the water was then removed from the coupling agent solution to functionalize the bonding surface. Optionally, the removal of water is accomplished by exposing the coated bonding surface to elevated temperatures. In some embodiments, the bonding surface is dried at a temperature of at least 100 degrees for at least about 5 minutes.

Optionally, additives may be included in the coupling agent solution. For example, a small amount of a condensation catalyst such as ammonium fluoride can be used as a promoter for the condensation reaction. Preferably, the ammonium fluoride is present in the coupling agent solution in amounts ranging from 1 to 10 parts per million by weight and is used under acidic conditions. The coupling agent solution can also include other additives, such as wetting agents, antioxidants, antifoaming agents, processing aids, antistatic agents, and non-ionic surfactants.

As shown in block 106, an orthodontic adhesive is then applied to at least a portion of the bonding surface. The adhesive is a hydrophilic adhesive as indicated by having an average water uptake of at least 0.5 weight percent relative to its original weight, according to the Water Uptake Test described in the Examples, below. More preferably, the adhesive has an average water uptake of 1.0 weight percent or higher, and most preferably, the adhesive has a water uptake of 2.0 weight percent or higher.

Suitable adhesives may use hardenable components (e.g., photopolymerizable compounds) including ethylenically unsaturated compounds (which contain free radically active unsaturated groups). In the present invention, hardenable components are preferably present in a range from 10% to 40% by weight and more preferably in a range from 15% to 30% by weight, based on the overall weight of the adhesive. Examples of useful ethylenically unsaturated compounds include acrylic acid esters, methacrylic acid esters, hydroxy-functional acrylic acid esters, hydroxy-functional methacrylic acid esters, and combinations thereof.

The adhesives may include compounds having free radically active functional groups that may include monomers, oligomers, and polymers having one or more ethylenically unsaturated group. Suitable compounds contain at least one ethylenically unsaturated bond and are capable of undergoing addition polymerization. Such free radically polymerizable compounds include mono-, di- or poly-(meth)acrylates (i.e., acrylates and methacrylates) such as, methyl (meth)acrylate, ethyl acrylate, isopropyl methacrylate, n-hexyl acrylate, stearyl acrylate, allyl acrylate, glycerol triacrylate, ethyleneglycol diacrylate, diethyleneglycol diacrylate, triethyleneglycol dimethacrylate, 1,3-propanediol di(meth)acrylate, trimethylolpropane triacrylate, 1,2,4-butanetriol trimethacrylate, 1,4-cyclohexanediol diacrylate, pentaerythritol tetra(meth)acrylate, sorbitol hexacrylate, tetrahydrofurfuryl(meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenol A di(meth)acrylate, and trishydroxyethyl-isocyanurate trimethacrylate; (meth)acrylamides (i.e., acrylamides and methacrylamides) such as (meth)acrylamide, methylene bis-(meth)acrylamide, and diacetone (meth)acrylamide; urethane (meth)acrylates; the bis-(meth)acrylates of polyethylene glycols (preferably of molecular weight 200-500), copolymerizable mixtures of acrylated monomers such as those in U.S. Pat. No. 4,652,274 (Boettcher et al.), acrylated oligomers such as those of U.S. Pat. No. 4,642,126 (Zador et al.), and poly(ethylenically unsaturated) carbamoyl isocyanurates such as those disclosed in U.S. Pat. No. 4,648,843 (Mitra); and vinyl compounds such as styrene, diallyl phthalate, divinyl succinate, divinyl adipate and divinyl phthalate. Other suitable free radically polymerizable compounds include siloxane-functional (meth)acrylates as disclosed, for example, in PCT Publication Nos. WO00/38619 (Guggenberger et al.), WO01/92271 (Weinmann et al.), WO01/07444 (Guggenberger et al.), WO00/42092 (Guggenberger et al.) and fluoropolymer-functional (meth)acrylates as disclosed, for example, in U.S. Pat. Nos. 5,076,844 (Fock et al.) and 4,356,296 (Griffith et al.), and European Patent Publication Nos. EP-0373 384 (Wagenknecht et al.), EP-0201 031 (Reiners et al.), and EP-0201 778 (Reiners et al.). Mixtures of two or more free radically polymerizable compounds can be used if desired.

The hardenable component may also contain hydroxyl groups and ethylenically unsaturated groups in a single molecule. Examples of such materials include hydroxyalkyl (meth)acrylates, such as 2-hydroxyethyl(meth)acrylate and 2-hydroxypropyl(meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta-(meth)acrylate; and 2,2-bis[4-(2-hydroxy-3-ethacryloxypropoxy) phenyl]propane (bisGMA). Suitable ethylenically unsaturated compounds are also available from a wide variety of commercial sources, such as Sigma-Aldrich, St. Louis. Mixtures of ethylenically unsaturated compounds can be used if desired.

In certain embodiments hardenable components include polyethyleneglycol dimethacrylate (PEGDMA) having a molecular weight of approximately 400 grams/mol, bisGMA, urethane dimethacrylate (UDMA), glycerol dimethacrylate (GDMA), triethyleneglycol dimethacrylate (TEGDMA), bisphenol A bis(2-hydroxyethyl 2,6 ether)dimethacrylate (bisEMA6) as described in U.S. Pat. No. 6,030,606 (Holmes), and neopentylglycol dimethacrylate (NPGDMA). Various combinations of the hardenable components can be used if desired. In certain embodiments, crosslinking monomers such as UDMA may represent the entire hardenable component of the adhesive. Preferably adhesives as disclosed herein include at least 10% by weight, or preferably at least 15% by weight, ethylenically unsaturated compounds (e.g., with and/or without acid functionality), based on the overall weight of the adhesive. Moreover, adhesives as disclosed herein include at most 40% by weight, or preferably at most 30% by weight, ethylenically unsaturated compounds (e.g., with and/or without acid functionality), based on the overall weight of the adhesive.

Adhesives as disclosed herein may also include one or more hardenable components in the form of ethylenically unsaturated compounds with acid functionality. As used herein, ethylenically unsaturated compounds with acid functionality is meant to include monomers, oligomers, and polymers having ethylenic unsaturation and acid and/or acid-precursor functionality. Acid-precursor functionalities include, for example, anhydrides, acid halides, and pyrophosphates. The acid functionality can include carboxylic acid functionality, phosphoric acid functionality, phosphonic acid functionality, sulfonic acid functionality, or combinations thereof.

Ethylenically unsaturated compounds with acid functionality include, for example, α,β-unsaturated acidic compounds such as glycerol phosphate mono(meth)acrylates, glycerol phosphate di(meth)acrylates, hydroxyethyl(meth)acrylate (e.g., HEMA) phosphates, bis((meth)acryloxyethyl) phosphate, ((meth)acryloxypropyl) phosphate, bis((meth)acryloxypropyl) phosphate, bis((meth)acryloxy)propyloxy phosphate, (meth)acryloxyhexyl phosphate, bis((meth)acryloxyhexyl) phosphate, (meth)acryloxyoctyl phosphate, bis((meth)acryloxyoctyl) phosphate, (meth)acryloxydecyl phosphate, bis((meth)acryloxydecyl) phosphate, caprolactone methacrylate phosphate, citric acid di- or tri-methacrylates, poly(meth)acrylated oligomaleic acid, poly(meth)acrylated polymaleic acid, poly(meth)acrylated poly(meth)acrylic acid, poly(meth)acrylated polycarboxyl-polyphosphonic acid, poly(meth)acrylated polychlorophosphoric acid, poly(meth)acrylated polysulfonate, poly(meth)acrylated polyboric acid, and the like, may be used as components in the hardenable component system. Also monomers, oligomers, and polymers of unsaturated carbonic acids such as (meth)acrylic acids, aromatic (meth)acrylated acids (e.g., methacrylated trimellitic acids), and anhydrides thereof can be used. Certain adhesives for use in preferred methods of the present invention include an ethylenically unsaturated compound with acid functionality having at least one P—OH moiety.

Certain of these compounds are obtained, for example, as reaction products between isocyanatoalkyl(meth)acrylates and carboxylic acids. Additional compounds of this type having both acid-functional and ethylenically unsaturated components are described in U.S. Pat. Nos. 4,872,936 (Engelbrecht) and 5,130,347 (Mitra). A wide variety of such compounds containing both the ethylenically unsaturated and acid moieties can be used. Mixtures of such compounds can be used if desired.

Additional ethylenically unsaturated compounds with acid functionality include, for example, polymerizable bisphosphonic acids as disclosed for example, in U.S. Patent Publication No. 2004/0206932 (Abuelyaman et al.); AA:ITA:IEM (copolymer of acrylic acid:itaconic acid with pendent methacrylate made by reacting AA:ITA copolymer with sufficient 2-isocyanatoethyl methacrylate to convert a portion of the acid groups of the copolymer to pendent methacrylate groups as described, for example, in Example 11 of U.S. Pat. No. 5,130,347 (Mitra)); and those recited in U.S. Pat. Nos. 4,259,075 (Yamauchi et al.), 4,499,251 (Omura et al.), 4,537,940 (Omura et al.), 4,539,382 (Omura et al.), 5,530,038 (Yamamoto et al.), 6,458,868 (Okada et al.), and European Patent Publication Nos. EP 712,622 (Tokuyama Corp.) and EP 1,051,961 (Kuraray Co., Ltd.).

Adhesives as disclosed herein can also include combinations of ethylenically unsaturated compounds with acid functionality. Preferably the adhesives are self-adhesive and are non-aqueous. For example, such adhesives can include: a first compound including at least one (meth)acryloxy group and at least one —O—P(O)(OH)ₓ group, wherein x=1 or 2, and wherein the at least one —O—P(O)(OH)ₓ group and the at least one (meth)acryloxy group are linked together by a C₁-C₄ hydrocarbon group; a second compound including at least one (meth)acryloxy group and at least one —O—P(O)(OH)ₓ group, wherein x=1 or 2, and wherein the at least one —O—P(O)(OH)ₓ group and the at least one (meth)acryloxy group are linked together by a C5-C12 hydrocarbon group; an ethylenically unsaturated compound without acid functionality; an initiator system; and a filler. Such adhesives are described, for example, in U.S. Patent Publication No. 2007/0248927 (Luchterhandt et al.). Preferably adhesives as disclosed herein include at least 10% by weight, or preferably at least 15% by weight, ethylenically unsaturated compounds with acid functionality, based on the overall weight of the adhesive. Adhesives as disclosed herein include at most 40% by weight, or preferably at most 30% by weight, ethylenically unsaturated compounds with acid functionality, based on the total weight of the adhesive.

The adhesive may further include any number of various fillers known in the art. Examples of suitable fillers are naturally occurring or synthetic materials including, but not limited to: quartz (i.e., silica, SiO₂); nitrides (e.g., silicon nitride); glasses and fillers derived from, for example, Zr, Sr, Ce, Sb, Sn, Ba, Zn, and Al; feldspar; borosilicate glass; kaolin; talc; zirconia; titania; low Mohs hardness fillers such as those described in U.S. Pat. No. 4,695,251 (Randklev); and submicron silica particles (e.g., pyrogenic silicas such as those available under the trade designations AEROSIL, including “OX 50,” “130,” “150” and “200” silicas from Degussa Corp., Akron, Ohio and CAB-O-SIL M5 and TS-720 silica from Cabot Corp., Tuscola, Ill.). Organic fillers made from polymeric materials are also possible, such as disclosed in PCT Publication No. WO09/045,752 (Kalgutkar et al.).

Preferred non-acid-reactive filler particles include quartz (i.e., silica), submicron silica, zirconia, submicron zirconia, and non-vitreous microparticles of the type described in U.S. Pat. No. 4,503,169 (Randklev). Mixtures of these non-acid-reactive fillers are also contemplated, as well as combination fillers made from organic and inorganic materials.

Adhesives used in the present invention optionally include a fluoride-releasing material. The fluoride-releasing material may be a filler. The fluoride-releasing material used in the present invention may be naturally occurring or synthetic fluoride minerals, fluoride glass such as fluoroaluminosilicate glass, simple and complex inorganic fluoride salts, simple and complex organic fluoride salts or combinations thereof. Optionally these fluoride sources can be treated with surface treatment agents. The fluoride-releasing material may optionally be a metal complex.

Examples of fluoride-releasing material are fluoroaluminosilicate glasses as described, for example, in U.S. Pat. No. 3,814,717 (Wilson et al.), which may be optionally treated as described, for example, in U.S. Pat. No. 5,332,429 (Mitra et al.). Exemplary fluoride-releasing materials are disclosed, for example, in U.S. Pat. No. 6,126,922 (Rozzi et al.) and PCT Publication No. WO00/69393 (Brennan et al.).

When the fluoride-releasing material is a glass, preferably the adhesive includes at least about 10% by weight, more preferably at least about 20% by weight, or most preferably at least about 30% by weight fluoride-releasing material, based on the total weight of the adhesive. When the fluoride-releasing material is a glass, preferably the adhesive includes at most about 90% by weight, more preferably at most about 70% by weight, and most preferably at most about 50% by weight fluoride-releasing material, based on the total weight of the adhesive.

Adhesives used in the present invention include a hardener. Preferably, the hardener will induce hardening upon exposure to actinic radiation (e.g., the hardener includes a photoinitiator). When the polymerizable component includes free radical polymerizable groups, then the hardener is preferably selected to be a free radical initiator. Exemplary hardeners are disclosed, for example, in U.S. Pat. No. 6,126,922 (Rozzi et al.) and PCT Publication No. WO00/69393 (Brennan et al.). Preferred free radical photoinitiators include ternary photoinitiator systems as disclosed, for example, in U.S. Pat. No. 5,545,676 (Palazzotto et al.).

Useful visible light induced ternary photoinitiator systems preferably include a sensitizing compound (e.g., camphorquinone), an electron donor (e.g., sodium benzene sulfinate, amines, and amino alcohols), and an iodonium salt (e.g., diphenyliodonium chloride, bromide, iodide, or hexafluorophosphate).

Useful ultraviolet light-induced polymerization initiators preferably include ketones (e.g., benzyl and benzoin), acyloins, and acyloin ethers. Preferred ultraviolet light-induced polymerization initiators include 2,2-dimethoxy-2-phenylacetophenone available under the trade designation IRGACURE-brand 65 and benzoin methyl ether (2-methoxy-2-phenylacetophenone), both available from Ciba Specialty Chemicals, Basel, Switzerland.

The photoinitator is preferably capable of promoting hardening of the polymerizable components on exposure to light of a suitable wavelength and intensity. The photoinitiator is also preferably sufficiently shelf stable and free of undesirable coloration to permit its storage and use under typical orthodontic conditions. Visible light photoinitiators are preferred.

The photoinitiator should be present in an amount sufficient to provide the desired rate of hardening. This amount will be dependent in part on the light source, the thickness of the layer to be exposed to radiant energy, and the extinction coefficient of the photoinitiator. Typically, the photoinitiator components will be present at a total weight of about 0.001% to about 5%, more preferably about 0.01% to about 1%, based on the total weight of the adhesive.

The methods described are advantageous because they provide unexpectedly high bond strength when used with hydrophilic and water permeable adhesives, particularly those having an average water uptake of at least 0.5 weight percent relative to its original weight after hardening. Conventional surface functionalization methods were found to provide enhanced bond strength when used with hydrophobic adhesives, such as adhesives having an average water uptake less than 0.5 weight percent relative to its original weight after hardening. However, these same methods did not enhance bond strength when used with hydrophilic adhesives, such as adhesives having an average water uptake of at least 0.5 weight percent relative to its original weight after hardening.

The provided methods and articles overcome this limitation by functionalizing bonding surfaces in the presence of a pH-modified coupling agent solution, and particularly a pH-modified coupling agent solution that has minimal residual acid or residual base when dried.

### Packaged Assemblies

Optionally, and as indicated in block 108, the adhesive-coated orthodontic appliance is packaged for short-term or long-term storage prior to use by the orthodontic professional. An exemplary embodiment is illustrated in FIG. 2, which shows a packaged assembly 10 including a functionalized adhesive coated orthodontic appliance. As shown in the figure, the assembly 10 includes an orthodontic appliance 12 having a metallic bonding surface 14 for attachment to a tooth (not shown). The appliance 12 can represent any one of a variety of orthodontic appliances including orthodontic brackets, buccal tubes, lingual buttons, lingual sheaths, cleats, and orthodontic bands. In some embodiments, the appliance 12 is entirely made of metal. Alternatively, the appliance 12 is made of plastic or ceramic materials and coated with a layer of metal to provide the metallic bonding surface.

Preferably the bottom surface of the metallic bonding surface 14 has a concave compound contour that matches the convex compound contours of the patient's tooth surface (not shown). Optionally, the metallic bonding surface 14 is provided with grooves, particles, recesses, undercuts, a mesh base, or any other material or structure or combination thereof that facilitates bonding the appliance 12 directly to a patient's tooth. The assembly 10 further includes an adhesive 16 in contact with the metallic bonding surface 14. Advantageously, the adhesive 16 substantially or completely covers the bonding surface 14, thereby protecting the bonding surface 14 from contamination or degradation resulting from exposure to the outside environment. Characteristics of the adhesive 16 have already been described in detail above and will not be repeated here.

It should be understood that the assembly 10 can optionally include one or more additional adhesive layers in contact with metallic bonding surface 14 and/or adhesive 16. Specifically, such additional layer(s) can reside between the metallic bonding surface 14 and the adhesive 16; on the adhesive 16 opposite the metallic bonding surface 14, or both. Such layers may or may not cover the same area, and may independently be discontinuous (e.g., a patterned layer) or continuous (e.g., non-patterned) materials extending across all or a portion of the metallic bonding surface 14.

Preferably and as shown, the assembly 10 also includes a release substrate 25 including a surface 27 that is in contact with the adhesive 16. The release substrate 25 may be selected from a number of materials including, for example, polyolefins, poly(vinyl chloride), polyurethanes, and poly(tetrafluoroethylene). Optionally, the surface 27 of the release substrate 25 comprises a number of pores, and preferably no more than 50% by weight of the adhesive 16 is within the pores. In certain embodiments, the release substrate 25 includes closed-cell foam materials as disclosed, for example, in U.S. Pat. No. 6,183,249 (Brennan et al.).

The assembly 10 is preferably packaged in a container that provides barriers to the transmission of light and/or water vapor. In some embodiments of the present invention, the assembly 10 is provided as a kit. In other embodiments, the present invention provides a method of bonding the orthodontic appliance 12 to a tooth in which the adhesive 16 includes one or more fillers of the type described.

The adhesives of the present invention can also be adapted for indirect bonding methods. For indirect bonding methods, orthodontic appliances are typically placed, for example, on a replica model (such as one made from orthodontic stone or cured epoxy) of the patient's dental arch to provide a custom base for later mounting on the patient's tooth structure, commonly using a placement device or transfer tray. In one embodiment, the orthodontic appliances have an adhesive coated on their respective bases thereon for bonding to the replica model. Thus, the adhesive can be seated against the replica model to form a custom base, for example, upon hardening of the adhesive. Exemplary indirect bonding methods are described in greater detail in U.S. Pat. No. 7,137,812 (Cleary et al.).

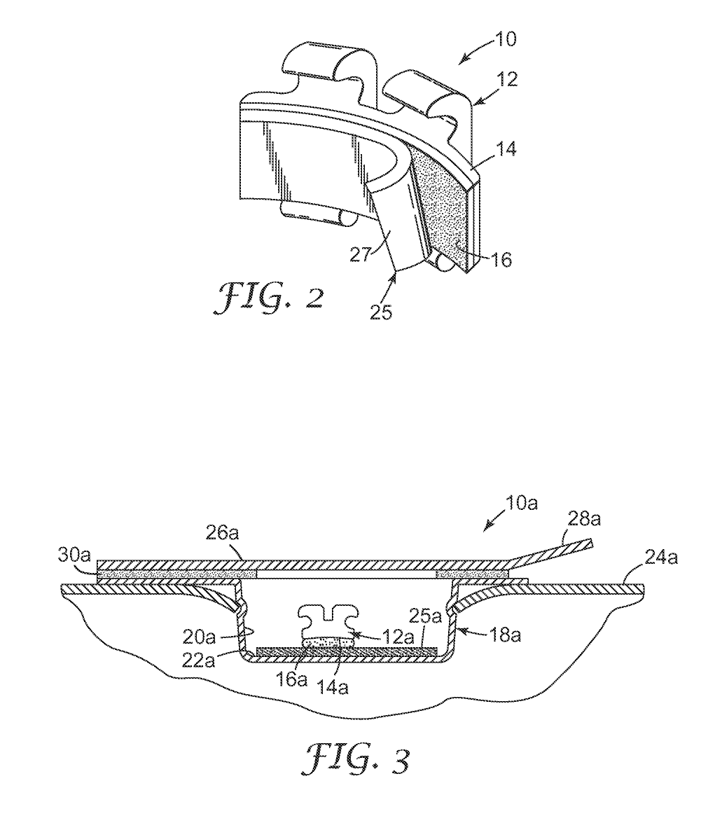

In another embodiment, referring to FIG. 3, the present invention provides a packaged assembly 10a including an orthodontic appliance 12a. The appliance 12a has a metallic bonding surface 14a for directly bonding the appliance 12a to a patient tooth structure (not shown). An adhesive 16a extends across the metallic bonding surface 14a of the bracket 12a. The bracket 12a and the adhesive 16a are surrounded by a container 18a. Optionally, the container 18a only partially surrounds the bracket 12a and the adhesive 16a.

As illustrated in FIG. 3, the container 18a includes an integrally-molded body with internal wall portions that define a recess or well 20a. The well 20a includes side walls and a bottom 22a. As an additional option, the side walls of the well 20a include horizontally extending recesses for engagement with edge structure of carrier 24a. Additional characteristics regarding the carrier 24a are set out in U.S. Pat. No. 5,328,363 (Chester et al.). Preferably, the bottom 22a of the well 20a includes a release substrate 25a. Preferably, the container 18a also includes a removable cover 26a with a tab 28a, with the cover 26a being releasably connected to the container 18a by, for example, an adhesive foam 30a.

In preferred embodiments, the container 18a provides excellent protection against degradation of the adhesive(s) (e.g., photopolymerizable compounds), even after extended periods of time. The container 18a is particularly useful for embodiments in which the adhesive 16a includes dyes that impart a color changing feature to the adhesive, as described previously. In these cases, it is further preferable that the container 18a effectively blocks the passage of actinic radiation over a broad spectral range, and as a result, the adhesive 16a does not prematurely lose color during storage.

In preferred embodiments, the container 18a comprises a polymer and metallic particles. As an example, the container 18a may be made of polypropylene that is compounded with aluminum filler or receives an aluminum powder coating as disclosed, for example, in U.S. Patent Publication No. 2003/0196914 (Tzou et al.).

The combination of polymer and metallic particles is highly effective in blocking the passage of actinic radiation to color changing dyes, even though such dyes are known to be highly sensitive to light. Such containers also exhibit good vapor barrier properties. As a result, the rheological characteristics of the adhesive(s) are less likely to change over extended periods of time. For example, the improved vapor barrier properties of such containers provide substantial protection against degradation of the handling characteristics of orthodontic adhesives so that they do not prematurely cure or dry or become otherwise unsatisfactory.

The cover 26a can be made of any material that is substantially opaque to the transmission of actinic radiation so that the adhesives therein do not prematurely cure. Examples of suitable materials for the cover 26a include laminates of aluminum foil and polymers. For example, the laminate may comprise a layer of polyethyleneterephthalate, adhesive, aluminum foil, adhesive and oriented polypropylene.

In some embodiments, a packaged assembly can include a set of two or more orthodontic appliances, wherein at least one of the appliances has an orthodontic adhesive thereon. Additional examples of appliances and sets of appliances are described in U.S. Patent Publication No. 2005/0133384 (Cinader et al.). Packaged orthodontic assemblies are further described, for example, in U.S. Pat. Nos. 4,978,007 (Jacobs et al.), 5,015,180 (Randklev), 5,328,363 (Chester et al.), and 6,183,249 (Brennan et al.).

### EXAMPLES

Objects and advantages of this invention are further illustrated by the following examples. While particular materials and amounts thereof are provided herein, these should not be construed to unduly limit this invention. Unless otherwise noted, all parts and percentages are on a weight basis and all molecular weights are weight average molecular weight. Also unless otherwise noted, all solvents and reagents were obtained from Sigma-Aldrich Corp. in St. Louis, Mo.

As used herein,

“Ammonium fluoride” refers to 370 ppm ammonium fluoride solution, prepared by diluting 1 M ammonium fluoride aqueous solution provided by Emerald Biosystems in Bainbridge Island, Wash.;

“Ammonium hydroxide” refers to 1.0% ammonium hydroxide solution prepared by diluting 28-30% ammonium hydroxide aqueous solution provided by Acros Organics in Geel, BELGIUM;

“APC II” refers to the APC II brand Adhesive Coated Appliance System, provided by 3M Unitek in Monrovia, Calif.;

“APC PLUS” refers to APC PLUS brand Adhesive Coated Appliance System, provided by 3M Unitek in Monrovia, Calif.;

“Carbon dioxide” refers to carbon dioxide gas generated by dry ice provided by Praxair, Inc. in Danbury, Conn.;

“GAA” refers to Glacial Acetic Acid, provided by EMD Chemicals in Gibbstown, N.J.;

“MPS” refers to 3-methoxypropyltrimethoxysilane, provided under the trade designation a“GF 31” by Wacker Chemie AG in Munchen, GERMANY;

“RelyX” refers to 3M ESPE RELY X brand ceramic primer, provided by 3M Company in St. Paul, Minn.;

“SIL” refers to 3M ESPE SIL brand silane primer, provided by 3M Company in St. Paul, Minn.;

“Trifluoroacetic acid” refers to 1% trifluoroacetic acid aqueous solution prepared by diluting trifluoroacetic acid provided by Aldrich Chemical Company in St. Louis, Mo.

### Sample Preparation

Silane coupling agent solutions were either commercially obtained or prepared in house. For example, RelyX and SIL were commercially available, while other silane coupling agent solutions were prepared by diluting MPS with distilled water, or in some cases with ethanol.

In some cases, the silane solution was pH-adjusted. In some cases, the pH of the silane solution was adjusted by adding incremental amounts of GAA, trifluoroacetic acid, or ammonium hydroxide into the solution until a certain pH value was reached. In other cases, pH was adjusted by bubbling carbon dioxide gas through the solution to form carbonic acid. In each case, the pH of the solution was monitored using pH indicator strips provided by EM Science in Gibbstown, N.J.

Silane treated brackets were prepared by sandblasting the mesh bases of stainless steel brackets (VICTORY SERIES brand upper central brackets, part no. 017-401 or 017-501, from 3M Unitek in Monrovia, Calif.) with ROCATEC PLUS media delivered by a Rocatec Jr. blasting module, provided by 3M Company in St. Paul, Minn. The sandblasting pressure was set at 2.8 bar and the distance between the nozzle and the bracket bonding base was set at 10 millimeters according to the manufacturer's recommendations. The blasting media was directed perpendicular to the surface of the bracket bonding base and sustained for approximately 2 seconds per bracket. After sandblasting, each bracket was lightly tapped to remove loose blasting media.

A thin layer of the silane solution was then lightly brushed onto the mesh base of each bracket. Unless otherwise noted, silane drying was carried out by placing the bracket in a convection oven at 100 degrees Celsius for 5 minutes. After the silane drying was complete, approximately 10 milligrams of either APC II or APC PLUS adhesive was coated onto the bonding base of each bracket. Each adhesive-coated bracket was then placed in a blister container and sealed with a laminated aluminum foil lidding. The container and lidding materials were identical to those used for APC II or APC PLUS.

Shear Peel and Tensile Bond Strength Tests

All shear bond strength measurements were conducted on uncut bovine teeth, which were cleaned and partially embedded in circular polymethylmethacrylate discs with the labial tooth surface exposed. All teeth were pumiced with fine powdered Italian pumice (obtained from Servalab, Inc. in Maywood, N.J.), followed by rinsing with water and drying using an air syringe immediately prior to bonding. The dry enamel was then etched and primed by rubbing TRANSBOND PLUS brand Self Etching Primer (from 3M Unitek in Monrovia, Calif.) on each tooth for 3 seconds according to the instructions for use for this primer. A gentle air burst was used to thinly spread and dry the primer on the tooth surface to be bonded.

To prepare each test specimen, an adhesive-coated bracket was removed from its sealed blister container, and the base of the bracket was firmly seated onto the tooth surface. Excess adhesive expressed around the periphery of the bracket base was subsequently removed using cotton pliers, taking care not to inadvertently disturb the bracket position. The adhesive was then photocured by exposure to actinic radiation using an ORTHOLUX LED brand curing light unit (from 3M Unitek in Monrovia, Calif.) for 5 seconds on each of the mesial and distal sides of the bracket. The above process was repeated for as many bonding test specimens as needed to obtain a complete set of replicated samples. After all specimens were fully bonded, they were submerged in water maintained at 37 degrees Celsius for 16-24 hours.

Debonding was conducted on each test specimen using a Q-TEST brand 5 Universal Test Machine (from MTS in Eden Prairie, Minn.) outfitted with a 1000 newton load cell. For each debonding, the test specimen was mounted in a fixture, then a 0.51 millimeter (0.020 inch) diameter stainless steel wire fixed to a crosshead was looped beneath the occlusal tiewings of the bracket and the crosshead was translated upwards at a speed of 5.1 millimeters (0.20 inches) per minute in a direction parallel to the tooth surface until shear failure was observed. Raw force data were converted to force per unit area (in megapascals) using the known bracket base area (10.6 square millimeter, or 0.0164 square inches, for the VICTORY SERIES brand upper central brackets used).

To maintain consistency, all samples within a series were tested in one sitting by a single operator. For each adhesive tested, the mean and standard deviation of shear bond strength were reported for a set of at least ten replicated test measurements.

In the tensile bond strength test, a tensile debonding fixture was used to secure the test specimen. The tensile debonding fixture allowed the bracket to be pulled in a direction perpendicular to the tooth surface. Other aspects of the test were essentially identical to those of the shear peel bond strength test described above.

### Water Uptake Test

The adhesive was pressed into the form of a disk between two sheets of release liner (SCOTCHPAK brand 1022, from 3M Company) using steel shims to set the thickness of 0.010 inches (0.25 millimeters) and light cured using an ORTHOLUX brand LED curing light. Disk samples were weighed to obtain the initial weights. Disk samples were then immersed in water for 24 hours at 40 degrees Celsius, removed from water, blotted dry to remove excess water and re-weighed to obtain the final weights. The water uptake is calculated as the weight gain (final weight minus initial weight) as a percentage of the initial weight. For each adhesive tested, the mean and standard deviation of water uptake were reported for a set of three replicated test measurements.

Examples 1-5 and Comparative Examples CE-1 and CE-2

Shear peel bond strength measurements were performed with stainless steel brackets using APC II adhesive. Examples 1-5 and Comparative Example CE-1 were prepared using the Sample Preparation procedure described above. As shown in Table 1, five pH-adjusted silane treatment conditions (Examples 1-5) were compared to a non-pH-adjusted silane treatment condition (CE-1) and an untreated condition (CE-2).

Example 1 was treated using 1.0% MPS solution in water that is pH-adjusted with GAA. Example 2 was treated using 1.0% MPS solution in water also pH-adjusted with GAA, with the addition of ammonium fluoride at a concentration of 5 parts per million. Example 3 was treated using 1.0% MPS solution in water that was bubbled with carbon dioxide gas, Example 4 was treated with 1.0% MPS solution in water that is pH-adjusted with trifluoroacetic acid, and Example 5 was treated with RelyX, which was pH-adjusted to have a pH ranging from 4.2 to 4.6. CE-1 was treated with SIL, an MPS coupling agent provided in ethanol solution (not pH-adjusted), and CE-2 was subjected to neither sandblasting nor silane treatment. A pH measurement for Comparative Example CE-1 is not applicable, because SIL was not in an aqueous solution.

Each adhesive-coated bracket was stored at room temperature in a sealed blister container for one week. The brackets were subsequently bonded to teeth and tested according to the Shear Peel Bond Strength Test described above. The shear peel bond strength data are shown in Table 1. Each result is represented by the numerical average of 20 replicated test measurements.

TABLE 1
Shear peel bond strength data for Examples 1-5 and CE-1, CE-2

| Example/ | | | Coupling | Shear peel |
|---|---|---|---|---|
| compara- | | Coupling agent | agent | bond strength |
| tive | Adhesive | solution | solution pH | (MPa) |
| 1 | APC II | 1.0% MPS in | 3.0 | 25.4 ± 4.7 |
| | | water/GAA | | |
| 2 | APC II | 1.0% MPS in | 3.0 | 22.7 ± 4.7 |
| | | water/ | | |
| | | GAA/ammonium | | |
| | | fluoride | | |
| 3 | APC II | 1.0% MPS in | 4.2 | 26.5 ± 5.9 |
| | | water/carbon | | |
| | | dioxide | | |
| 4 | APC II | 1.0% MPS in | 3.0 | 24.2 ± 5.6 |
| | | water/ | | |
| | | trifluoro- | | |
| | | acetic acid | | |
| 5 | APC II | RelyX | 4.2-4.6 | 23.0 ± 5.0 |
| CE-1 | APC II | SIL | — | 20.4 ± 6.6 |
| CE-2 | APC II | None | — | 16.7 ± 2.8 |

### Examples 6-10 and Comparative Example CE-3

Shear peel bond strength measurements were performed on stainless steel brackets coated with APC PLUS adhesive. Like in Examples 1-5, five different pH-adjusted silane treatment conditions were tested (Examples 6-10) and compared with the untreated condition (Comparative Example CE-3). The adhesive-coated brackets were stored, bonded, and tested as previously described for Examples 1-5 and Comparative Examples CE-1 and CE-2. The shear peel bond strength data are shown in Table 2 below. Each result is represented by the numerical average of 10 replicated test measurements.

TABLE 2
Shear peel bond strength data for Examples 6-10 and CE-3

| Example/ | | | Coupling | Shear peel |
|---|---|---|---|---|
| compara- | | Coupling agent | agent | bond strength |
| tive | Adhesive | solution | solution pH | (MPa) |
| 6 | APC PLUS | 1.0% MPS in | 3.0 | 19.0 ± 5.7 |
| | | water/GAA | | |
| 7 | APC PLUS | 1.0% MPS in | 3.0 | 19.3 ± 4.7 |
| | | water/GAA/ | | |
| | | ammonium | | |
| | | fluoride | | |
| 8 | APC PLUS | 1.0% MPS in | 4.2 | 20.6 ± 4.1 |
| | | water/carbon | | |
| | | dioxide | | |
| 9 | APC PLUS | 1.0% MPS in | 3.0 | 24.3 ± 5.7 |
| | | water/ | | |
| | | trifluoro- | | |
| | | acetic acid | | |
| 10 | APC PLUS | RelyX | 4.2-4.6 | 19.8 ± 5.8 |
| CE-3 | APC PLUS | None | — | 14.3 ± 1.4 |

### Example 11 and Comparative Examples CE-4 and CE-5

Shear peel bond strength measurements were again performed on stainless steel brackets coated with APC PLUS adhesive. Example 11 was treated with a pH-adjusted silane provided by a 1.0% MPS/water solution adjusted to a pH of 3.0 using GAA, Comparative Example CE-4 was treated with a commercially available silane, SIL (not pH-adjusted), and Comparative Example CE-5 was neither sandblasted nor silane treated. In these tests, drying of the silane solution took place at 100 degrees Celsius for 20 minutes. The adhesive-coated brackets were stored, bonded, and tested as previously described for Examples 1-5 and Comparative Examples CE-1 and CE-2. The shear peel bond strength data are shown in Table 3, below. Each result is represented by the numerical average of 30 replicated test measurements.

TABLE 3
Shear peel bond strength data for Example 11 and CE-4, CE-5

| Example/ | | | Coupling | Shear peel |
|---|---|---|---|---|
| compara- | | Coupling agent | agent | bond strength |
| tive | Adhesive | solution | solution pH | (MPa) |
| 11 | APC PLUS | 1.0% MPS in | 3.0 | 22.7 ± 5.7 |
| | | water/GAA | | |
| CE-4 | APC PLUS | SIL | — | 16.9 ± 4.6 |
| CE-5 | APC PLUS | None | — | 15.6 ± 3.2 |

### Examples 12-13 and Comparative Example CE-6

Tensile bond strength measurements were performed on stainless steel brackets coated with APC PLUS adhesive under various conditions. Example 12 was silane treated with 1.0% MPS/water solution adjusted to a pH of 3.0 using GAA, example 13 was silane treated with RelyX (having a pH ranging from 4.2 to 4.6), and Comparative Example CE-6 was neither sandblasted nor silane treated. The adhesive-coated brackets were stored, bonded, and tested as previously described for Examples 1-5 and Comparative Examples CE-1 and CE-2. The tensile bond strength data are shown in Table 4, below. Each result is represented by the numerical average of at least 28 replicated test measurements.

TABLE 4
Tensile bond strength data for Examples 12-13 and CE-6

| Example/ | | | Coupling | |
|---|---|---|---|---|
| compara- | | Coupling agent | agent | Tensile bond |
| tive | Adhesive | solution | solution pH | strength (MPa) |
| 12 | APC PLUS | 1.0% MPS in | 3.0 | 6.1 ± 1.3 |
| | | water/GAA | | |
| 13 | APC PLUS | RelyX | 4.2-4.6 | 6.5 ± 1.2 |
| CE-6 | APC PLUS | None | — | 5.0 ± 1.2 |

### Examples 14-17 and Comparative Example CE-7

Shear peel bond strength measurements were performed on stainless steel brackets coated with APC PLUS adhesive. Examples 14 and 15 were silane treated under acidic conditions using MPS/ethanol/water solutions at MPS concentrations of 0.25% and 2%, respectively, providing a pH ranging from 4.2-4.6. Example 16 was silane treated under basic conditions with 1.0% MPS/water solution adjusted with an amount of ammonium hydroxide sufficient to obtain a pH of 8.5-9.2. Example 17 was silane treated with RelyX (having a pH ranging from 4.2 to 4.6) and Comparative Example CE-7 was neither sandblasted nor silane treated. The adhesive-coated brackets were stored, bonded, and tested as previously described for Examples 1-5 and Comparative Examples CE-1 and CE-2. The shear peel bond strength data are shown in Table 5, below. Each result is represented by the numerical average of 30 replicated test measurements.

TABLE 5
Shear peel bond strength data for Examples 14-17 and CE-7

| Example/ | | | Coupling | Shear peel |
|---|---|---|---|---|
| compara- | | Coupling agent | agent | bond strength |
| tive | Adhesive | solution | solution pH | (MPa) |
| 14 | APC PLUS | 0.25% MPS | 4.2-4.6 | 22.5 ± 6.6 |
| | | in 74.75% | | |
| | | ethanol/25% | | |
| | | water/GAA | | |
| 15 | APC PLUS | 2.0% MPS | 4.2-4.6 | 22.8 ± 5.6 |
| | | in 73% | | |
| | | ethanol/25% | | |
| | | water/GAA | | |
| 16 | APC PLUS | 1.0% MPS in | 8.5-9.2 | 20.6 ± 5.1 |
| | | water/ | | |
| | | ammonium | | |
| | | hydroxide | | |
| 17 | APC PLUS | RelyX | 4.2-4.6 | 24.7 ± 4.9 |
| CE-7 | APC PLUS | None | — | 16.6 ± 4.8 |

### Water Uptake Measurements on Adhesives Used in Examples 1 to 17 and Comparative Examples CE-1 to CE-7

The water uptake values of the APC II and APC PLUS adhesives used in the Examples and Comparative Examples above were measured using the Water Uptake Test described above. The water uptake values are shown in Table 6 below.

TABLE 6
Average water uptake values for APC II and APC PLUS

| | Average water |
|---|---|
| | uptake (weight %) |
| APC II | 0.23 ± 0.058 |
| APC PLUS | 2.5 ± 0.15 |

All of the patents and patent applications mentioned above are hereby expressly incorporated into the present disclosure. The foregoing invention has been described in some detail by way of illustration and example for purposes of clarity and understanding. However, various alternatives, modifications, and equivalents may be used and the above description should not be taken as limiting in the scope of the invention which is defined by the following claims and their equivalents.

1. A method of making an adhesive-coated orthodontic appliance comprising:
providing a metallic bonding surface on the orthodontic appliance for attachment to a tooth surface;
sand blasting the bonding surface with a silica-based media;
functionalizing the bonding surface in the presence of a pH-modified coupling agent solution; and
applying an adhesive onto at least a portion of the bonding surface, the adhesive having an average water uptake of at least 0.5 weight percent relative to its original weight after hardening.

2. The method of claim 1, wherein the adhesive has an average water uptake of at least 1.0 weight percent of its original weight after hardening.

3. The method of claim 2, wherein the adhesive has an average water uptake of at least 2.0 weight percent of its original weight after hardening.

4. The method of claim 1, wherein the coupling agent solution is an acidic coupling agent solution having a pH ranging from 2.0 to 5.0.

5. The method of claim 4, wherein the acidic coupling agent solution has a pH ranging from 2.8 to 4.6.

6. The method of claim 4 wherein the acidic coupling agent solution comprises a volatile acid thereby minimizing acidic residue when the coupling agent solution is dried.

7. The method of claim 6 wherein the acid is selected from the group consisting of: trifluoroacetic acid and carbonic acid.

8. The method of claim 1, wherein the coupling agent solution is a basic coupling agent solution having a pH ranging from 8.0 to 10.0.

9. The method of claim 8, wherein the coupling agent solution has a pH ranging from 8.5 to 9.2.

10. The method of claim 8, wherein the basic coupling agent solution comprises ammonium hydroxide.

11. The method of claim 1, wherein the silica-based media comprises silica-coated alumina.

12. The method of claim 1, wherein the metallic bonding surface comprises stainless steel.

13. The method of claim 1, wherein the adhesive is hardenable by exposure to actinic radiation.

14. The method of claim 1, wherein the orthodontic appliance comprises a non-metallic body at least partially coated with a metallic layer.

15. The method of claim 1, wherein the adhesive is fluoride releasing.

16. The method of claim 1, further comprising placing the adhesive-coated orthodontic appliance in a container having a removable cover.

17. A packaged orthodontic assembly comprising:
an orthodontic appliance having a functionalized metallic bonding surface for attachment to a tooth surface, the bonding surface functionalized in the presence of a pH-modified coupling agent solution;
an adhesive in contact with the bonding surface, the adhesive having an average water uptake of at least 0.5 percent of its original weight after hardening; and
a container at least partially surrounding the orthodontic appliance and adhesive thereon.
